(19) United States
(12) Patent Application Publication
(10) Pub. No.: US 2011/0271532 A1
(43) Pub. Date: Nov. 10, 2011

(54) CABLE CONTROL SET FOR EXTENDED REACH GARDEN SHEARS

(75) Inventor: Shih-Piao Wu, Lu Kang Town (TW)

(73) Assignee: JIIN HAUR INDUSTRIAL CO.,LTD., Lu Kang Town (TW)

(21) Appl. No.: 12/776,427

(22) Filed: May 10, 2010

(51) Int. Cl. A01G 3/025

(52) U.S. Cl. 30/249

(57) ABSTRACT

Extended reach garden shears have a cutting section comprising two blades pivoted together; the cutting section is attached to an upper end of an extension rod via a swing device, and the cutting section is capable of being driven by a cable. The cable passes around a pulley and then into the extension rod, and after a predetermined length exits the extension rod and attaches to a sliding cover jacketed onto an external periphery of the extension rod. Two rollers are pivoted onto a predetermined location of the extension rod, and the cable is placed between the two rollers. Each roller further includes grooves around its outer periphery such that the cable is sandwiched in the grooves. Furthermore, a limiting sheet is mounted onto an extending portion of the extension rod adjacent to the two rollers.

### BACKGROUND OF THE INVENTION

1. Field of the Invention

The present invention relates to a cable control set for extended reach garden shears, and more particularly to a cable control set capable of smoothly controlling the extension reach of the garden shears.

2. Description of the Related Art

Currently, typical extended reach garden shears are used for trimming branches or harvesting fruit from trees, thereby relieving users of the need for climbing and increasing work efficiency.

However, typical extended reach garden shears require significant strength to operate their control cables, which is very inconvenient and difficult. Furthermore, the cable may come into direct contact with the extended reach garden shears when pulled or changing a swing angle of the head portion of the extended reach garden shears, which can lead to abrasion of the cable.

Therefore, it is desirable to provide a cable control set for extended reach garden shears to mitigate and/or obviate the aforementioned problems.

### SUMMARY OF THE INVENTION

An objective of the present invention is to provide a cable control set for extended reach garden shears which is capable of smoothly controlling extended reach garden shears.

In order to achieve the above-mentioned objectives in the cable control set for extended reach garden shears of the present invention, extended reach garden shears have a cutting section comprising a moveable blade and a fixed blade pivoted together; the cutting section is attached to an upper end of an extension rod via a swing device, and the cutting section is capable of being driven by a cable. The cable passes around a pulley and then into the extension rod, and after a predetermined length exits the extension rod and attaches to a sliding cover jacketed onto an external periphery of the extension rod, such that the sliding cover is capable of sliding along the extension rod in response to the cable to control movements of the cutting section. Two rollers are pivoted onto a predetermined location of the extension rod, and the cable is placed between the two rollers. Each roller further includes grooves around its outer periphery such that the cable is sandwiched within the grooves. Furthermore, a limiting sheet is mounted onto an extending portion of the extension rod adjacent to the two rollers.

Compared to the prior art, in the present invention, when the cable is pulled downward, upward or by way of the swing device, it is always smoothly guided by the two rollers, which can reduce the required strength for operations. Moreover, the pivoted rollers are also used as a separator between the cable and the extension rod, such that when the cable is pulled by the sliding cover or the swing device for different cutting angles, the cable does not rub against the extension rod and is thus free from abrasion to provide a longer lifetime.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a local detailed view of an embodiment of the present invention.

FIG. 3 is a perspective exploded view of an embodiment of the present invention.

FIG. 4 is a side view of an embodiment of the present invention.

FIG. 5 illustrates usage of cable movement according to an embodiment of the present invention.

FIG. 6 illustrates movement of a swing device of an embodiment of the present invention.

### DETAILED DESCRIPTION OF THE PREFERRED EMBODIMENT

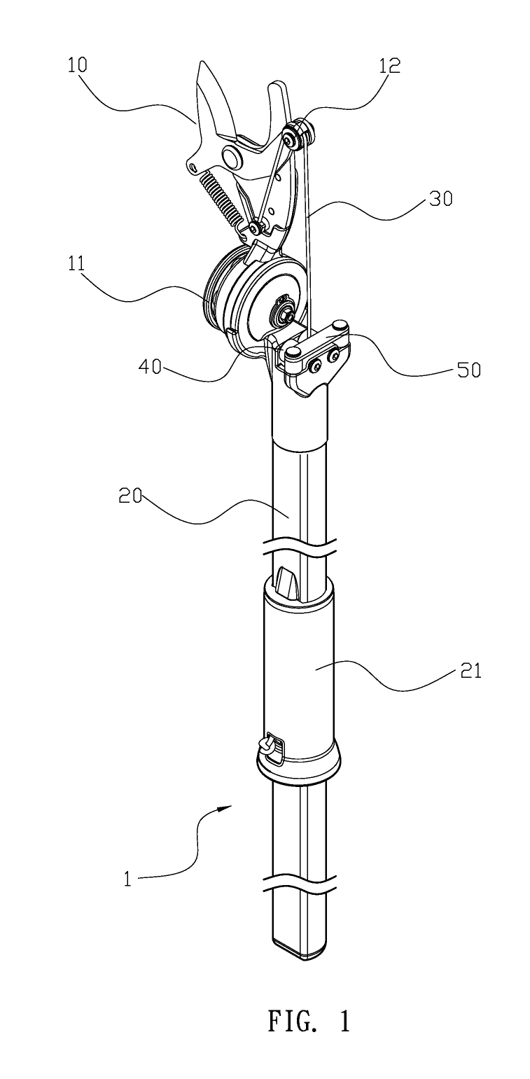

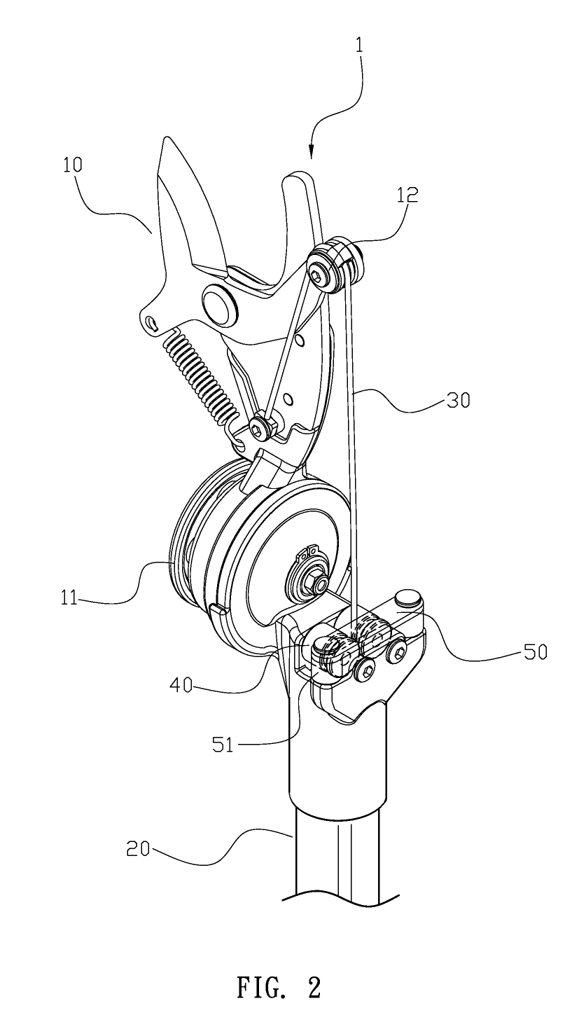

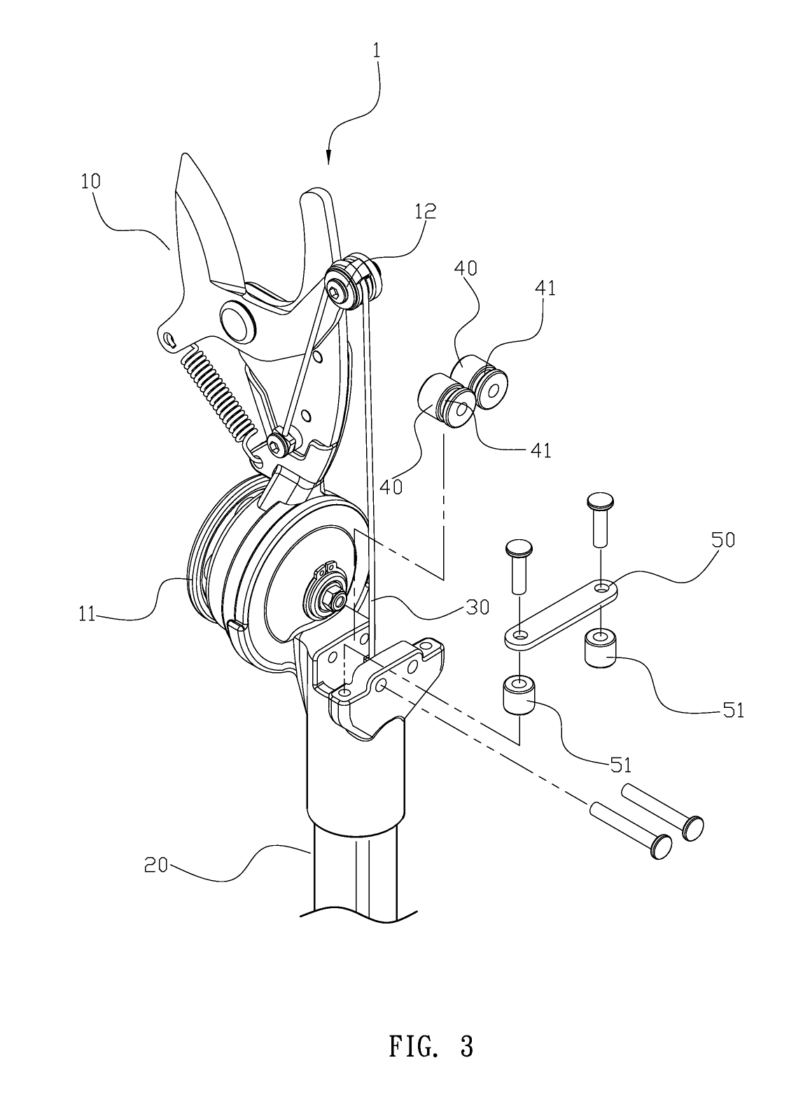

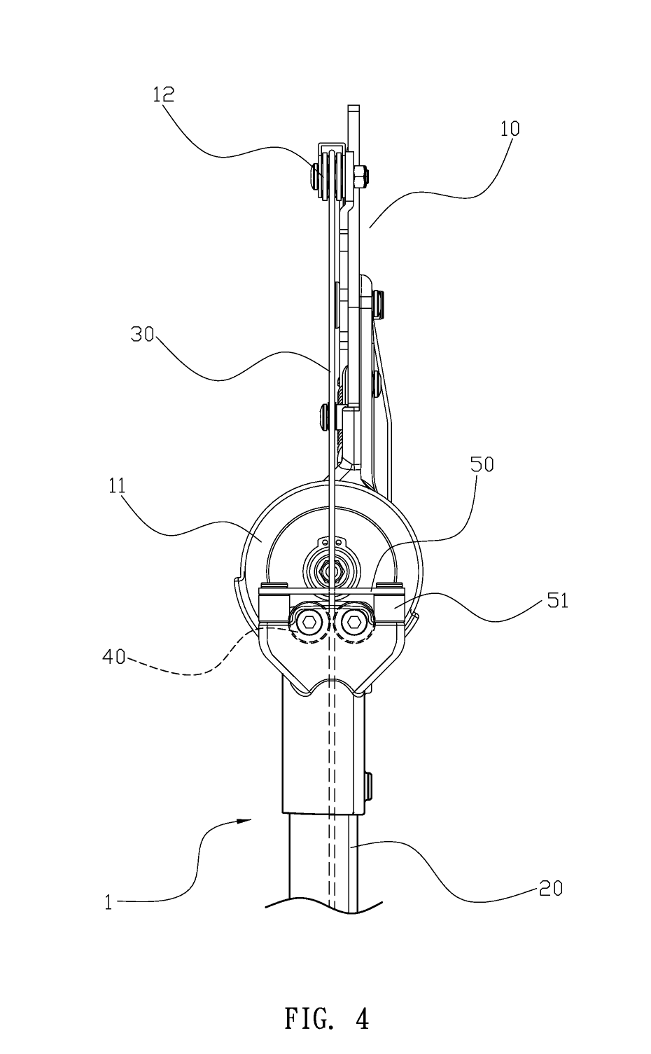

Please refer to FIG. 1 to FIG. 4. Extended reach garden shears 1 have a cutting section 10 comprising a moveable blade and a fixed blade pivoted together; the cutting section 10 is attached to an upper end of an extension rod 20 via a swing device 11, and the cutting section 10 is capable of being driven by a cable 30. The cable 30 passes around a pulley 12 and then into the extension rod 20, and after a predetermined length exits the extension rod 20 and attaches to a sliding cover 21 jacketed onto an external periphery of the extension rod 20, such that the sliding cover 21 is capable of sliding along the extension rod 20 in response to the cable to control movements of the cutting section 10. Two rollers 40 are pivoted onto a predetermined location of the extension rod 20, and the cable 30 is placed between the two rollers 40. Each roller includes grooves 41 around its outer periphery such that the cable 30 is sandwiched within the grooves 41. Furthermore, a limiting sheet 50 is mounted onto an extending portion 51 of the extension rod 20 adjacent to the two rollers 40.

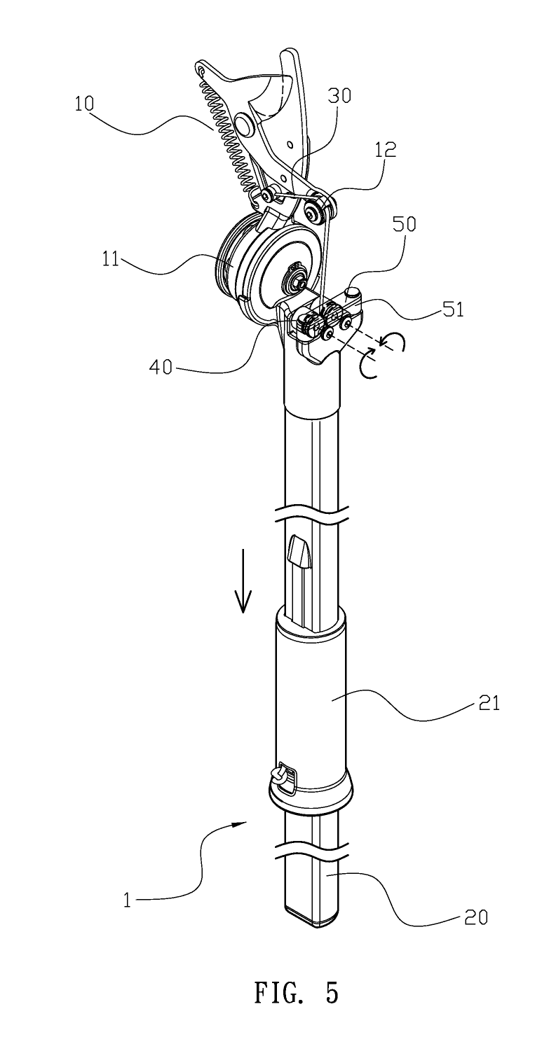

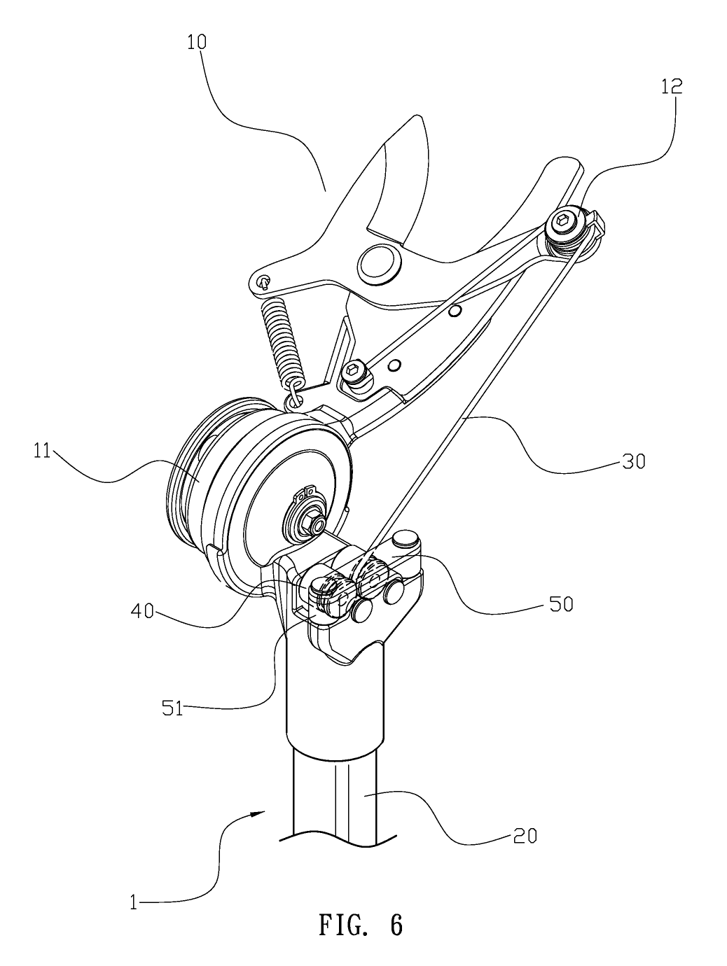

For operations, before being used, two blades of the cutting section 10 are held open in order to place branches between them. When the user places the blades at a proper position to cut off the branch, he or she pushes down the sliding cover 21 to pull down the cable 30 to drive the moveable blade towards to the fixed blade, such that the branch placed between the two blades of the cutting section 10 is cut off. After the cutting movement, he or she can release the sliding cover 21 to enable the moveable blade of the cutting section 10 to be pulled back to the original position by an attached spring. The cable 30 and the sliding cover 21 are pulled simultaneously, and the two rollers are pivoted to both sides of the cable 30 to smoothly slide the cable 30. Therefore, when the cable 30 is pulled downward, upward or by the swing device, it is always smoothly guided by the two rollers 40, as shown in FIG. 5, which can reduce the required strength for operations. Moreover, the pivoted rollers 40 are also used as a separator between the cable 30 and the extension rod 20, such that when the cable 30 is pulled by the sliding cover 21 or the swing device 11 for different cutting angles, as shown in FIG. 6, the cable 30 does not nib against the extension rod 20 and is thus free from abrasion to provide a longer lifetime.

Although the present invention has been explained in relation to its preferred embodiment, it is to be understood that many other possible modifications and variations can be made without departing from the spirit and scope of the invention as hereinafter claimed.

What is claimed is:

1. A cable control set for extended reach garden shears, the extended reach garden shears having a cutting section comprising at least two blades pivoted together, the cutting section attached to a first location of an extension rod, the cutting section capable of being driven by the cable; characterized in that:
at least two rollers are pivoted onto a second location of the extension rod, and the cable is placed between the two rollers;
wherein when the cable is pulled, the two rollers rotate to provide a smoother movement.

2. The cable control set for extended reach garden shears as claimed in claim 1, wherein the cutting section utilizes a swing device that couples to the extension rod.

3. The cable control set for extended reach garden shears as claimed in claim 1, wherein the cable passes around a pulley and then into the extension rod, and after a predetermined length exits the extension rod and attaches to a sliding cover jacketed onto an external periphery of the extension rod, such that the sliding cover is capable of sliding along the extension rod in response to the cable to control movements of the cutting section.

4. The cable control set for extended reach garden shears as claimed in claim 1, wherein each roller further includes grooves around its outer periphery such that the cable is sandwiched in the grooves.

5. The cable control set for extended reach garden shears as claimed in claim 1, wherein a limiting sheet is attached onto the extension rod adjacent to the rollers.

6. The cable control set for extended reach garden shears as claimed in claim 5, wherein the limiting sheet is mounted onto an extending portion of the extension rod.
